(19) United States
(12) Patent Application Publication
(10) Pub. No.: US 2024/0326117 A1
(43) Pub. Date: Oct. 3, 2024

(54) VERFAHREN ZUM HERSTELLEN EINES REINIGUNGSARMS EINES REINIGUNGSSYSTEMS

(71) Applicant: Robert Bosch GmbH, Stuttgart (DE)

(72) Inventors: Aleksandar Stanisic, Belgrade (RS); Mirko Vucetic, Nova Pazova (RS)

(21) Appl. No.: 18/617,806

(22) Filed: Mar. 27, 2024

(30) Foreign Application Priority Data
Mar. 30, 2023 (DE) 102023202913.8

(51) Int. Cl. B21K 1/26; B60S 1/34; B60S 1/40

(52) U.S. Cl. CPC B21K 1/26; B60S 1/3429; B60S 1/4041

(57) ABSTRACT

The present invention relates to a method (100) for manufacturing a cleaning arm (10) of a cleaning system (200), comprising the steps of: cold forming (S1) of a blank with at least one hole (11) for forming a bottom element (12), a side element (14) formed to be essentially orthogonal to the bottom element (12), a bushing (16) for attaching the cleaning arm (10) to a cleaning motor (202) of the cleaning system (200), a web (18), wherein the hole (11) is disposed on the web (18), wherein the hole (11) is positioned such that a stud (20) can be positioned in the hole (11) for attaching a spring (26).

### BACKGROUND

The present invention relates to a method for manufacturing a cleaning arm of a cleaning system, a cleaning arm for a cleaning system, and a vehicle.

There are currently a large number of different solutions for manufacturing components for cleaning systems in the vehicle sector. Due to the increasing number of sensors to be cleaned on the vehicle, the need for effective cleaning systems is constantly growing.

Continuous weight reduction in the vehicle sector to reduce consumption and increasing competition are putting pressure on costs, so that there is greater demand for cheaper and more efficient components for vehicles.

### SUMMARY

The method according to the invention for manufacturing a cleaning arm of a cleaning system has the advantage over the known method that the manufacturing process can be significantly simplified, since the cleaning arm is manufactured by means of one manufacturing step and thus the cycle time can be significantly increased. In addition, manufacturing by means of cold forming, such as punching and/or deep drawing, makes it possible to incorporate a variety of design alternatives into the cleaning arm. For example, a stud for attaching a spring to the cleaning arm can be attached by means of punching without having to carry out additional manufacturing steps.

This is achieved according to the invention in that the method for manufacturing a cleaning arm of a cleaning system comprises the steps:
of cold forming of a blank with at least one hole for forming:
of a bottom element,
of a side element which is formed to be essentially orthogonal to the bottom element,
of a bushing for attaching the cleaning arm to a cleaning motor of the cleaning system,
of a web, wherein the hole is disposed on the web, wherein the hole is positioned so that a stud can be positioned in the hole for attaching a spring.

In particular, the cleaning system is a windshield wiper system. The cleaning arm is, in particular, a wiper arm of the windshield wiper system, preferably intended to hold a wiper blade.

In other words, a cleaning arm is formed using a cold forming process such as punching and/or deep drawing. Using a prefabricated blank of the cleaning arm, it is formed in one production step in such a way that the side element, the bushing, and the web can be brought into their final position in one production step. In particular, the side element is disposed around the entire bottom element. Furthermore, the side element is preferably disposed at an angle to the bottom element, which is essentially 90°. Essentially, this means a deviation of ±45°. Furthermore, the method can be used to bend the web on the blank so that the hole on the web is positioned in such a way that a stud can be inserted into the hole and then a spring can be mounted on the stud, which is set up to form a preload on the windshield wiper.

Preferably, the web extends from a side element. In particular, the web is bent in such a way that it extends to an opposite side element and lies against it in a particularly advantageous manner.

The dependent claims disclose preferred embodiments of the invention.

Preferably, the cold forming of the blank comprises the step:
of cutting out an opening in the bottom element, wherein the opening is designed to guide a hose from an outer side of the cleaning arm to an inner side of the cleaning arm.

One advantage of this embodiment is that the opening provides a simple means of guiding the hose around the component. Furthermore, the opening or the cutting out of the opening can have the advantage that no further manufacturing step is necessary to provide a hose guide on the cleaning arm.

Preferably, the blank has a pin, wherein the cold forming of the blank comprises the step:
of bending the pin so that the pin secures the hose to the side element.

The cold forming of the blank also preferably comprises the step:
of cutting out a second recess, wherein the second recess is disposed in such a way that the spring can be disposed on the stud.

One advantage of this embodiment is that the assembly process of the spring on the stud is simplified. The second recess is preferably disposed on the web. This means that the second recess on the blank can be cut out first and then the web can be bent into a corresponding position.

One advantage of this embodiment is that the pin prevents the hose from slipping in the cleaning arm, which is particularly advantageous in that a vibration or similar does not cause the hose to chafe.

A further aspect of the invention is a cleaning arm for a cleaning system, wherein the cleaning arm has a bottom element and a side element, which are formed in one piece, wherein the cleaning arm has a web with a hole, wherein the side element and the web are formed in one piece, wherein a stud can be disposed in the hole in such a way that a spring can be disposed on the stud.

An advantage of this embodiment is that the cleaning arm can be formed by means of a prefabricated blank in order to simultaneously form the functionality for preloading a windshield wiper by means of the spring, so that in particular no rust or the like can occur due to welding or the like.

Preferably, the side element has at least a third recess for securing a pin, which secures a windshield wiper to the cleaning arm. The windshield wiper is also called a wiper blade.

One advantage of this embodiment is that the windshield wiper can be disposed on the cleaning arm by means of a simple force-fit and/or form-fit connection.

A further aspect of the invention relates to a vehicle comprising a cleaning system with a cleaning arm as described above and below.

### BRIEF DESCRIPTION OF THE DRAWINGS

In the following, exemplary embodiments of the invention are described in detail with reference to the accompanying drawing. The drawings show:

FIGS. 1 through 4 a cleaning arm according to one embodiment,

FIG. 5 a flowchart illustrating steps of the method according to one embodiment, and

FIG. 6 a vehicle according to one embodiment.

### DETAILED DESCRIPTION

Preferably, all identical components, elements, and/or units are provided with the same reference symbols in all figures.

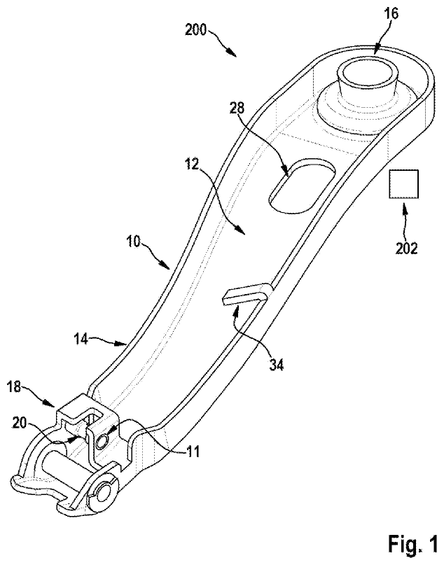

FIG. 1 shows a cleaning arm 10. The cleaning arm 10 comprises a bottom element 12. Furthermore, the cleaning arm 10 has a side element 14, which is formed in one piece with the bottom element 12. As can be seen in FIG. 1, the side element 14 is preferably disposed orthogonally to the bottom element 12. The cleaning arm 10 also preferably comprises a bushing 16. The bushing 16 is used to attach the cleaning arm 10 to a cleaning rotary motor 202 of the cleaning system 200. Furthermore, the cleaning arm 10 comprises a pin 34, which can secure a hose 22 in the cleaning arm 10. Furthermore, the cleaning arm 10 comprises an opening 28 which can be used to guide the hose 22 from the outer side 30 of the cleaning arm 10 to an inner side 32 of the cleaning arm 10. The cleaning arm 10 also comprises a web 18. The web 18 comprises a hole 11 in which a stud 20 can be disposed. A spring 26 can be disposed on the cleaning arm 10 by means of the stud 20.

FIG. 2 shows a cleaning arm 10, which has a second recess 24 on the web 18 for positioning a spring 26. The stud 20 is disposed on the web 18 in such a way that the spring 26 can be disposed on the stud 20. Further preferably, the cleaning arm 10 has a third recess 36. A pin 38 can be disposed in the third recess 36 to secure a windshield wiper 40 to the cleaning arm 10.

FIG. 3 shows an embodiment of the cleaning arm 10. The cleaning arm 10 has an outer side 30 and an inner side 32. The opening 28 of the cleaning arm 10 can be set up to guide the hose 22 from the outer side 30 to the inner side 32. The cleaning arm 10 also has a web 18 with a hole 11 in which the stud 20 can be disposed.

FIG. 4 shows the cleaning arm 10 according to one embodiment. The cleaning arm 10 has a web 18 with a hole 11 in which a stud 20 can be disposed. Furthermore, the cleaning arm 10 comprises a third recess 36 for securing a stud 38.

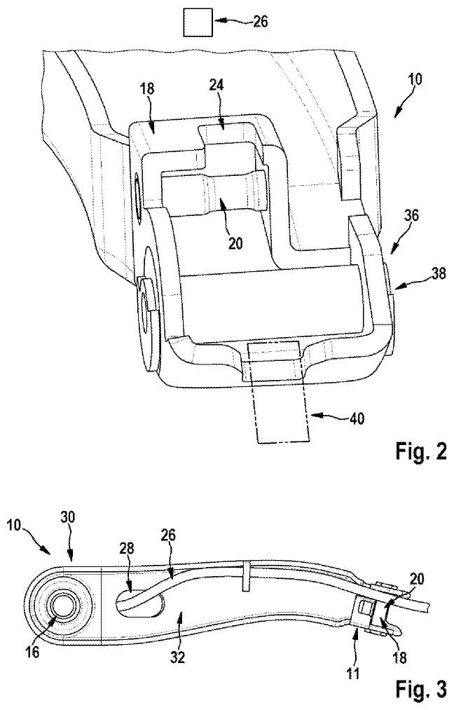

FIG. 5 shows the method 100 for manufacturing a cleaning arm 10 of a cleaning system 200 comprising the steps:
of cold forming S1 of a blank with at least one hole 11 for forming:
of a bottom element 12,
of a side element 14, which is formed to be essentially orthogonal to the bottom element 12,
of a bushing 16 for attaching the cleaning arm 10 to a cleaning rotary motor 202 of the cleaning system 200,
of a web 18, wherein the hole 11 is disposed on the web 18, wherein the hole 11 is positioned such that a stud 20 can be positioned in the hole 11 to secure a spring 26 to the stud.

The method further comprises the step S2 of cutting out an opening 28 in the bottom element 12, wherein the opening 28 is arranged to guide the hose 22 from an outer side 30 of the cleaning arm 10 to an inner side 32 of the cleaning arm 10.

Furthermore, the method 100 comprises step S3 of bending the pin 34 so that the pin 34 secures the hose 22 to the side element 14.

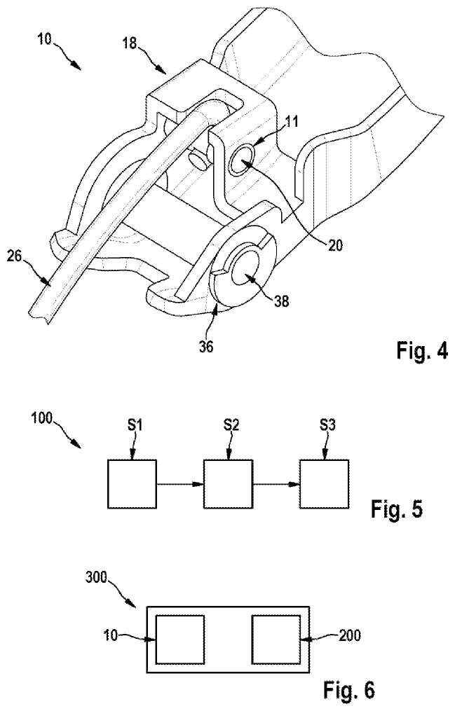

FIG. 6 shows a vehicle 300 comprising a cleaning arm 10 as described above and below and a cleaning system 200.

1. A method (100) of manufacturing a cleaning arm (10) of a cleaning system (200), comprising the steps of:
cold forming (S1) of a blank with at least one hole (11) for forming:
of a bottom element (12),
of a side element (14), which is formed to be essentially orthogonal to the bottom element (12),
of a bushing (16) for attaching the cleaning arm (10) to a cleaning motor (202) of the cleaning system (200),
of a web (18), wherein the hole (11) is disposed on the web (18), wherein the hole (11) is positioned such that a stud (20) can be positioned in the hole (11) for attaching a spring (26).

2. The method according to claim 1, wherein cold forming the blank comprises the step of:
cutting out (S2) an opening (28) in the bottom element (12), wherein the opening (28) is arranged to guide a hose (22) from an outer side (30) of the cleaning arm (10) to an inner side (32) of the cleaning arm.

3. The method of claim 2, wherein the blank comprises a pin (34), wherein cold forming the blank comprises the step of:
bending (S3) of the pin (34) so that the pin (34) secures the hose (22) to the side element (14).

4. A method according to claim 1, wherein cold forming the blank comprises the step of:
cutting out a second recess (24), wherein the second recess (24) is disposed in such a way that the spring (26) can be disposed on the stud (20).

5. A cleaning arm (10) for a cleaning system (200), wherein the cleaning arm (10) has a bottom element (12) and a side element (14), which are formed in one piece, wherein the cleaning arm (10) has a web (18) with a hole (11), wherein the side element (14) and the web (18) are formed in one piece, wherein a stud (20) can be disposed in the hole (11) in such a way that a spring (26) can be disposed on the stud (20).

6. The cleaning arm according to claim 5, wherein the side element (14) has at least a third recess (66) for fixing a pin (38) which secures a windshield wiper (40) to the cleaning arm (10).

7. A vehicle (300) comprising a cleaning system (200) with a cleaning arm (10) according to claim 5.
